(19) United States
(12) Patent Application Publication
(10) Pub. No.: US 2026/0192475 A1
(43) Pub. Date: Jul. 9, 2026

(54) Segmented Solar Concentrator Manufacturing and Assembly for Achieving Imaging and Nonimaging Irradiance Properties

(71) Applicant: Exowatt, Inc., Miami, FL (US)

(72) Inventors: Ehsan Ordouie, Miami, FL (US); Ralf Leutz, Miami, FL (US)

(21) Appl. No.: 19/428,035

(22) Filed: Dec. 19, 2025

Related U.S. Application Data
(60) Provisional application No. 63/739,112, filed on Dec. 26, 2024.

(51) Int. Cl. B26D 3/24; F24S 23/30; G02B 3/08; G02B 19/00

(52) U.S. Cl. CPC B26D 3/24; G02B 3/08; F24S 23/31; G02B 19/0042

(57) ABSTRACT

A large-area optical element such as a primary solar concentrator being a Fresnel lens is cut into segments. Produced parts are reassembled at diametrically translated positions. The resulting segmented concentrator is nonimaging with implications for uniformity of irradiance on receiver as peak irradiance is cut and homogeneity in the focal plane increases. The more segments are produced and assembled, the more homogeneous the irradiance patterns of the resulting concentrator becomes.

### CROSS-REFERENCE TO RELATED APPLICATIONS

This application claims benefit of U.S. Provisional Ser. No. 63/739,112 filed Dec. 26, 2024, which is incorporated herein by reference in its entirety and for all purposes.

### FIELD

The technology herein relates to solar concentrators such as Fresnel lenses and more particularly to enjoying loss-free means to dilute the concentrated sunlight at the level of the primary concentrator in a prescribed manner.

### BACKGROUND

Primary solar concentrator optics such as Fresnel lenses or mirrors are often designed with imaging properties, namely the sun is imaged into the focal plane of the concentrator producing an image of the sun. The smaller the image of the sun in the focus at a given entry aperture area of the concentrator, the closer the concentration is to the thermodynamic maximum.

In the thermodynamic maximum, the concentration is near 42,000, and the temperature in the focal image approaches that of the surface of the sun at approximately 6,000 K.

While these values are impressive, they are not always desirable. Materials in the focal area of the concentrator may not withstand such temperatures, for example. The peak of irradiance in the focus should be cut, and a more homogeneous distribution of the irradiance in the focal plane should be achieved.

One common way to reduce the concentration and the temperature in the focal area may involve dilution of the concentrated sunlight by means of secondary optical elements. As the sunlight passes optical surfaces and materials with associated losses of reflection and absorption, respectively, the system efficiency tends to be reduced.

For example, WO2010059657A3 discloses a Köhler concentrator which follows an optical principle where primary optical elements focus light into the focal planes of obligatory secondary optical elements.

The manufacturing process of a large-area concentrator may encompass (a) diamond turning or milling of a master mold, as a whole or in segments; (b) cutting of the master mold into segments for replication and production; (c) production of parts; and (d) the assembly of the parts to form a concentrator in operation. It would be desirable to provide structures and techniques that reduce concentration and temperature as part of the design and such manufacturing of the large area concentrator itself without the need for additional or secondary optical structures.

### BRIEF DESCRIPTION OF THE DRAWINGS

FIG. 1 shows a full prior art Fresnel lens as an example of a primary solar concentrator.

FIG. 2 shows different segmentation strategies:
Case 1: Cutting two or more segments for imaging assembled lens. Segments' positions remain identical to virtual segments'positions in full lens
Case 2: Cutting two or more segments for nonimaging lens. Segments cut in positions 2 are assembled in positions 1, vice versa, or at any other position in line with the translation described.

FIG. 3 shows an example of Case 1: Cutting of master into segments and positioning of parts accounting for frame elements, where the concentrator retains imaging properties in principle.

FIG. 4 shows an example of Case 2: Cutting of segments through master center, and reassembling produced parts at diametrically translated positions; the resulting segmented concentrator is nonimaging with implications for uniformity of irradiance on receiver (homogeneity).

FIG. 5a shows an example irradiance distribution of a Fresnel lens concentrator in the receiver plane based on an imaging design (exaggerated illustration).

FIG. 5b shows an example irradiance distribution of a Fresnel lens concentrator in the receiver plane with the design using Case 2 tailoring with four segments of the irradiance distribution to create a wider, more homogeneous distribution (exaggerated illustration).

### DETAILED DESCRIPTION OF NON-LIMITING EMBODIMENTS

Example non-limiting technology herein provides techniques and structures for enjoying loss-free means to dilute the concentrated sunlight at the level of the primary concentrator in a prescribed manner.

Example embodiments cut the irradiance peak, and increase the homogeneity of the irradiance in the focal plane in a prescribed manner, by adjusting the manufacturing of the primary optical concentrator.

Any practical primary solar concentrator needs to be manufacturable. Introducing means, structures and/or modifications to dilute the concentrated sunlight is desirably equally cost effective and mechanically feasible. We describe a method to cut the peak irradiance and increase the homogeneity of the concentrated sunlight in the focal plane to be implemented during what is usually the second step of manufacturing a very large-area solar concentrator (although other embodiments can use any size and/or shape of concentrator). Large-area in one example embodiment describes a concentrator with an entry aperture commonly measured in multiples of square meters. Such optical elements can be replicated and produced in segments of a master, the parts produced from the segments of the master being assembled for operation, to take advantage of cost-effective and optically suitable manufacturing processes like casting, hot embossing and injection (compression) molding. Manufacturing often set limits of the maximum area processed. That can be table or chamber sizes in batch processes, and the width of roll-to-roll processes, to give some examples. Therefore, it is advantageous to produce the large-area concentrator in segments. It does not matter whether the segments are obtained by cutting a monolithic master into segments, creating the master in segments using segmented materials such as brass sheets, or creating master segments individually in processes as off-axial diamond turning or milling. This description of the master manufacturing applies to subsequent manufacturing processes.

As noted above, the manufacturing process of a large-area concentrator may encompass (a) the diamond turning or milling of the master mold, as a whole or in segments; (b) the cutting of the master mold into segments for replication and production; (c) the production of parts; and (d) the assembly of the parts to form a concentrator in operation.

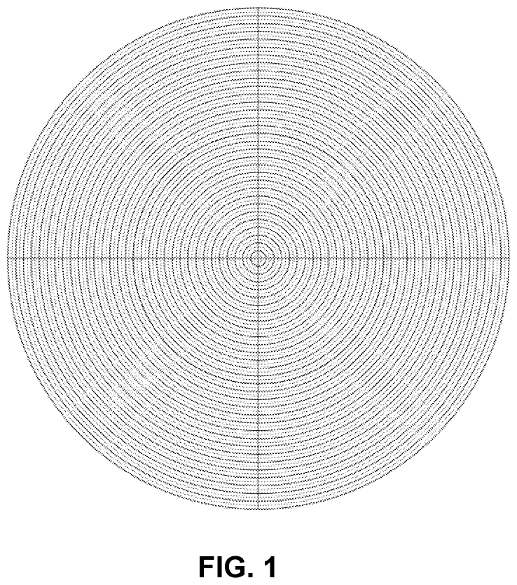

The FIG. 1 prior art Fresnel lens may comprise a circular or any other patterns of acrylic, plastic or glass, with concentric, stepped rings that mimic a curved lens but which are much thinner, lighter, and cheaper. Each ring is a flat or curved surface at a specific angle, acting like a tiny prism to bend (refract) light. The stepped rings are typically disposed on one side of the plastic or glass sheet, with the grooved side facing the light source (e.g., the sun). An example configuration for the lens shown could be Focal length=1300 (mm), Groove Pitch=0.5 (mm), Length=1100 (mm), Thickness=5 (mm), Width=1100 (mm).

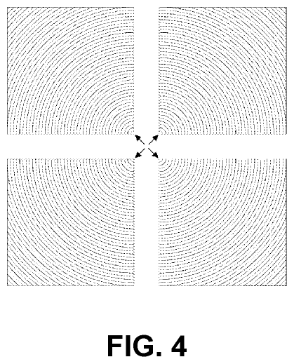

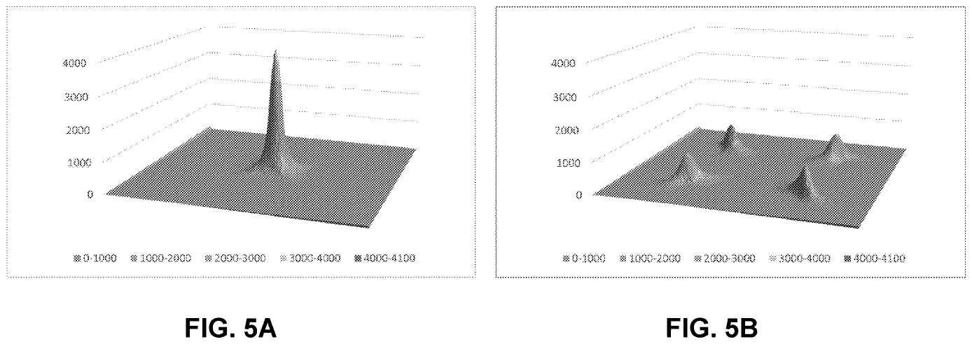

The basic function of the lens is to refract light emitted by the sun to condense the light. See FIG. 5a showing an example intensity distribution providing a very intense single focus for the light the sun emits. This single focus may reach high intensity levels that a receiver structure cannot withstand.

Example embodiments of the present technology cut a large-area optical element such as a primary solar concentrator being a Fresnel lens (FIG. 1) into segments. Example ways to do this include the following alternative strategies (FIG. 2):
Case 1: cutting two or more segments for imaging assembled lens. Segments'positions remain identical to virtual segments'positions in full lens, or
Case 2: cutting two or more segments for nonimaging lens. Segments cut in positions 2 are assembled in positions 1, or vice versa, or at any other position in line with the translation described.

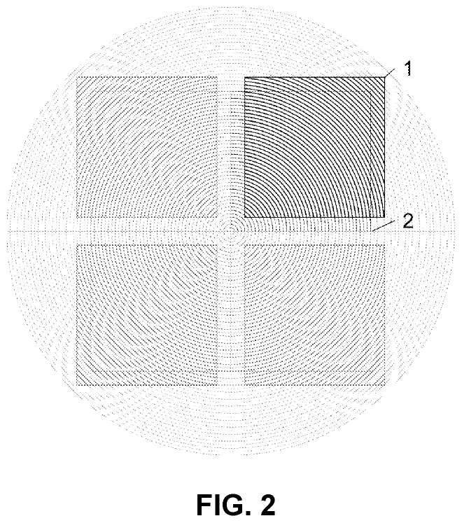

An example resulting assembled concentrator for Case 1 is shown in FIG. 3. The cutting of the master into segments and positioning of produced parts accounts for frame elements, and the concentrator retains its imaging properties in principle.

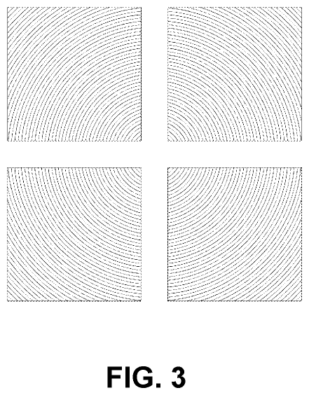

In the case of a nonimaging lens, energy transfer properties replace imaging properties when characterizing the lens. This may typically be the case with solar concentrator applications. For Case 2, an example of which is shown in FIG. 4, the master is cut into segments through its center, and produced parts are reassembled at diametrically translated positions. The resulting segmented concentrator is nonimaging with implications for uniformity of irradiance on the receiver as peak irradiance is cut and homogeneity in the focal plane increases.

The more segments are produced and assembled, the more homogeneous the irradiance patterns of the resulting concentrator becomes. In this example, the resulting concentrator is unable to produce a common single image of the source because of the translated positions of the produced parts. The resulting concentrator is thus not suitable for imaging or image magnification because it has intentionally been optically degraded. Such intentional optical degradation however results in more homogenous irradiance patterns that essentially spread the concentrated light out over a wider area instead of focusing the concentrated light in a very small tight area that could become so hot that it melts, damages or destroys an absorber placed to absorb the concentrated light.

In other embodiments, the size of the absorber(s) is/are increased to receive the homogenized concentrated light irradiance pattern over a wider area - which allows the absorber to potentially be made of less expensive, less heat resistant materials while still collecting and absorbing the irradiance concentrated by the concentrator.

The process described can be performed for any number of segments equal and greater than two. In one embodiment, the segments are quarters, and changing the quarter portions of the focal area leads to changes in uniformity of the irradiance there. Other embodiments could use triangular segments or any other regular or irregular shape.

Masters designed and manufactured with different focal lengths can be combined in the process described, as long as Fresnel lenses or Fresnel mirrors are concerned. This is one method to tailor the irradiance distribution in the target, suitable to be applied in Case 1 and in Case 2.

The irradiance pattern, including the irradiance homogeneity in the focal plane, can be tailored according to the strategy chosen and the number of segments selected. The more segments are used, the more uniform the irradiance distribution in the target. This method to tailor the irradiance distribution is suitable to be applied in Case 2.

To give an (exaggerated) illustration of the design possibilities for tailoring irradiance distributions, refer to FIGS. 5a and 5b for a comparison of the irradiance distributions of an imaging Fresnel lens and the same lens that underwent diametrical translation of its four segments as described in Case 2. The FIG. 5a intensity plot is for a normal lens with symmetry and no gaps between segments (or what could result if cut segments are placed very close together with no gaps or cut portions between segments). The resulting focal spot would be ideally what is shown in FIG. 5a. When the lens is cut into four segments and the segments are moved away from their common optical axis, the resulting intensity distribution would be as shown in FIG. 5b with four peaks (one for each segment). Each of the four peaks has a magnitude that is less than the magnitude of the single peak shown in FIG. 5a. In this case, the four peaks have the same magnitude because the segments are cut uniformly and have the same uniform size. Each of the four peaks is separated from the common optical axis by the same distance. This distance is determined by the lens parameters and the way the segments are cut.

It would also be possible cut the segments from the overall lens structure using a wide cutting blade to thereby remove material between the segments, and then move the segments to again be close together or contacting one another. This structure would also exhibit an intensity distribution as shown in FIG. 5b with four separate foci but with less separation between the four foci to provide a tight focus but with a reduced intensity of the type shown in FIG. 5a. In other words, gaps between the cut segments are not essential; it is the removal of parts of the regular concentric circle pattern of the lens that destroys the lens's single focal point characteristic and redistributes the focused energy to plural separated foci. One or plural solar absorbers can be designed and configured to provide absorption area(s) that are able to withstand the intensities of the focused energy

In one example embodiment, an existing, and commonly used manufacturing process is modified implementing strategies to produce large-area imaging, or nonimaging solar concentrators, depending on the strategy chosen. The present technology can be applied to any number of segments greater than one, allowing for flexibility in manufacturing, and reassembly. The resulting irradiance patterns are tailored in line with the number of segments selected.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method comprising:
cutting a Fresnel lens into plural segments; and
reassembling the plural segments at diametrically translated positions to dilute the concentrated sunlight at the level of the primary concentrator in a prescribed loss-free manner.

2. The method of claim 1 wherein cutting comprises cutting the Fresnel lens into quarters.

3. The method of claim 1 wherein reassembling the plural segments comprises leaving gaps between the segments.

4. The method of claim 1 wherein reassembling the plural segments comprises leaving no gaps between the segments.

5. The method of claim 1 further including passing light through the reassembled plural segments, the plural segments focusing the light into plural foci.
